(19) United States
(12) Patent Application Publication
(10) Pub. No.: US 2014/0043355 A1
(43) Pub. Date: Feb. 13, 2014

(54) METHOD AND APPARATUS FOR DYNAMIC IMAGE MANIPULATION IN A MOBILE TERMINAL

(71) Applicant: Samsung Electronics Co., Ltd., Gyeonggi-do (KR)

(72) Inventors: Kyusung KIM, Seoul (KR); Ho KIM, Seoul (KR); Uijeong PARK, Seoul (KR); Soojung BAE, Seoul (KR); Jeeyeun WANG, Seoul (KR); Seungju YUK, Seoul (KR)

(73) Assignee: Samsung Electronics Co., Ltd., Gyeonggi-do (KR)

(21) Appl. No.: 13/960,026

(22) Filed: Aug. 6, 2013

(30) Foreign Application Priority Data
Aug. 9, 2012 (KR) 10-2012-0087028

(51) Int. Cl. G06T 11/00

(52) U.S. Cl. CPC G06T 11/001
USPC 345/592

(57) ABSTRACT

A method for dynamic image manipulation and a mobile terminal supporting the same are disclosed. The method for dynamic image manipulation includes: outputting at least one thumbnail; receiving an input event; and performing image change by changing at least one of the shape, color and transparency of the output thumbnail according to properties of the input event.

### CROSS RELATED APPLICATION

This application claims the benefit under 35 U.S.C. §119(a) of a Korean patent application filed on Aug. 9, 2012, in the Korean Intellectual Property Office and assigned Serial No. 10-2012-0087028, the entire disclosure of which is hereby incorporated by reference.

### BACKGROUND

1. Field of the Invention

The present disclosure relates to the display of images and, more particularly, to a method for dynamic image manipulation and a mobile terminal supporting the same, wherein displayed images may be dynamically changed based on input events.

2. Description of the Related Art

Mobile terminals have become extremely popular in the past decade. Among them are ones enabling users to place and receive calls. This action has become a daily necessity and most mobile terminals come equipped with more than just this ability. Some examples of additional features offered by modern mobile terminals are file playback, file search, and file editing.

A mobile terminal may display text or images on its display unit to provide a variety of information. Images displayable by the mobile terminal may be diverse in size, but images used as, for example, photo ID images in a phonebook application tend to be very small. In most cases, images related to phonebook items are used as photo ID images when the user does not explicitly configure specific settings.

As these photo ID images do not change in shape and are limited in size, the amount of information, such as emotional information, provided to the user by these photo ID images is limited. This problem commonly occurs in other applications that use images and icons as thumbnails. Hence, it is desirable to develop a method that may provide a higher amount of diverse information, including emotional information, during output of fixed-size images.

### SUMMARY

The present invention provides an approach for dynamic image manipulation, wherein displayed images such as thumbnails may be dynamically manipulated so as to provide emotional information and other information in an adaptive manner.

In accordance with an exemplary embodiment of the present invention, there is provided a method for dynamic image manipulation that includes: outputting at least one thumbnail; receiving an input event comprising a plurality of properties; and performing image change by changing at least one of a shape, color, and transparency of the output thumbnail according to the plurality of properties of the input event.

In accordance with another exemplary embodiment of the present invention, there is provided a mobile terminal that includes: a display unit to output at least one thumbnail; at least one of a communication unit, an input unit, and a touch panel to receive an input event; and a control unit to change at least one of the shape, color and transparency of the output thumbnail according to properties of the input event.

### BRIEF DESCRIPTION OF THE DRAWINGS

The features and advantages of the present invention will be more apparent from the following detailed description in conjunction with the accompanying drawings, in which:

FIG. 1 is a block diagram of a mobile terminal configured in accordance with an embodiment of the present invention;

FIG. 2 is a block diagram illustrating a configuration of a control unit in the mobile terminal of FIG. 1;

FIG. 3 is a flowchart of a dynamic image manipulation process configured in accordance with another embodiment of the present invention;

FIG. 4 includes a series of screen displays that may be used to describe image modification operations that may occur in response to a scroll event using the dynamic image manipulation process of FIG. 3;

FIG. 5 includes a series of screen displays that may be used to describe image modification operations that may occur in response to the scroll event using the dynamic image manipulation process of FIG. 3;

FIG. 6 includes a series of screen displays that may be used to describe image modification operations that may occur in response to a search event using the dynamic image manipulation process of FIG. 3;

FIG. 7 includes a series of screen displays that may be used to describe image modification operations that may occur over a passage of time using the dynamic image manipulation process of FIG. 3;

FIGS. 8, 9 and 10 includes various images that may be used to describe image modification operations that may occur based on usage histories during the dynamic image manipulation process of FIG. 3;

FIGS. 11 and 12 includes various images that may be used to describe change of images in color and transparency based on usage histories during the dynamic image manipulation process of FIG. 3;

FIG. 13 includes a set of images that may be used in image modification operations according to user settings during the dynamic image manipulation process of FIG. 3; and

FIG. 14 includes a series of screen displays that may be used to describe modification of multiple thumbnails during the dynamic image manipulation process of FIG. 3.

### DETAILED DESCRIPTION

Hereinafter, embodiments of the present invention are described in detail with reference to the accompanying drawings. Detailed descriptions of well-known functions and structures incorporated herein may be omitted to avoid obscuring the subject matter of the present invention. For the purposes of clarity and simplicity, detailed descriptions of components having substantially the same configurations and functions may also be omitted. In the drawings, some elements may be exaggerated, omitted, or only outlined in brief, and thus may not be drawn to scale. Hence, the present invention should not be limited by the relative sizes of, or spaces between, objects in the drawings.

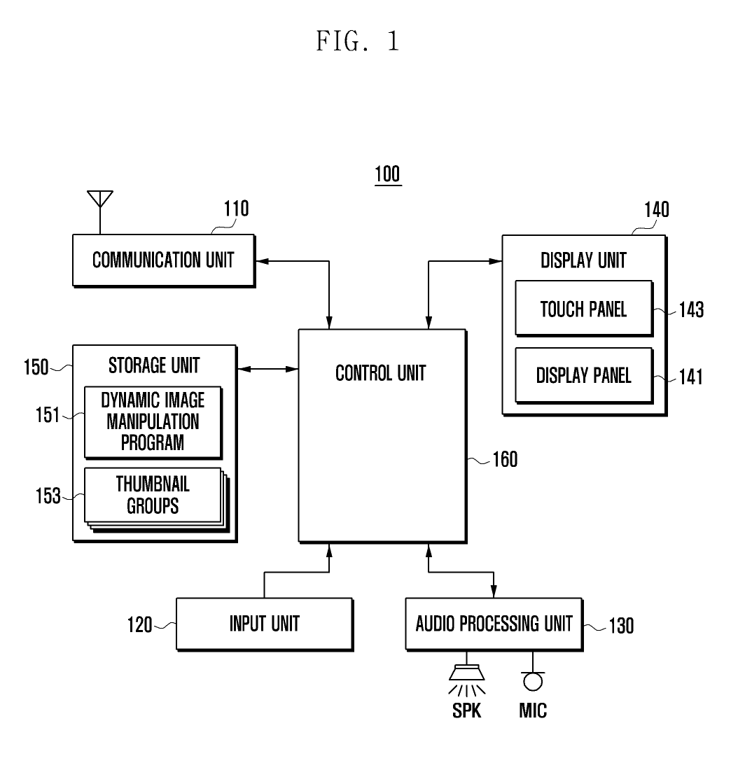

FIG. 1 illustrates a mobile terminal 100 configured to support dynamic image manipulation according to an embodiment of the present invention.

Referring to FIG. 1, the mobile terminal 100 may include a communication unit 110, an input unit 120, an audio processing unit 130, a display unit 140, a storage unit 150, and a control unit 160. In the following description, “displayed images” may refer to thumbnails that are reduced-size images much smaller than the full-screen size of the display unit 140.

According to the present invention, the mobile terminal 100 having the above configuration may store multiple groups of thumbnails 153 in the storage unit 150 and output a representative thumbnail for each thumbnail group 153 on the display unit 140. The mobile terminal 100 may support dynamic image configuration by replacing, for a thumbnail group, the displayed representative thumbnail with a new representative thumbnail according to an input event. Hence, the user may view a changing of displayed images based on input events received during execution of a specific function, and obtain various supplementary information including emotional information.

The communication unit 110 is configured to support communication of the mobile terminal 100 with other devices. Thus, when the mobile terminal 100 supports mobile communication functionality, the communication unit 110 may include a mobile communication module. When the mobile terminal 100 does not provide mobile communication functionality, the communication unit 110 may be omitted. The communication unit 110 may allow the mobile terminal 100 to receive various thumbnails from an external device or server, and store the received thumbnails in the storage unit 150 as members of a thumbnail group 153 under control of the control unit 160. When a thumbnail is received through the communication unit 110, the control unit 160 may create a thumbnail group 153 by modifying the thumbnail and storing it as a first thumbnail in the thumbnail group 153 in the storage unit 150.

In general, the input unit 120 may include side keys [Steve] and a separate touchpad. The input unit 120 may also include a key for turning the mobile terminal 100 on-or-off and a home key for returning the display unit 140 to a home screen. The input unit 120 may generate an input signal for activating a function using the thumbnail group 153, or for replacing images in the thumbnail group 153. Generated input signals may be delivered to the control unit 160 and used as commands for activating functions indicated by the input signals. When a display panel and a touch panel are provided, as further described herein, the input unit 120 may be realized using a touch map displayable on the display panel. The input unit 120 may generate an input signal for entering a search term based on user control. The input unit 120 may also generate an input signal for selecting an entry from a list of thumbnail groups 153.

The audio processing unit 130 is configured to provide input and output of audio signals for the mobile terminal 100. The audio processing unit 130 may include a speaker SPK to output an audio signal, and a microphone to receive an audio signal. In particular, the audio processing unit 130 may generate a sound effect or sound notification corresponding to an input event generated during the dynamic image manipulation process. For example, the audio processing unit 130 may produce a sound effect when an input event for scrolling a list of thumbnails is generated. Output of any sound effect or sound notification may be skipped according to user settings.

The display unit 140 is configured to display various screens necessary for operation of the mobile terminal 100. For example, the display unit 140 may display an idle screen, a menu screen, or a listing screen containing various thumbnails. In one aspect of the invention, the listing screen may be one of a phonebook list screen, a message list screen, a call log screen, a chat list screen, or a chat screen containing a chatting list. The display unit 140 may include a display panel 141 and a touch panel 143.

The display panel 141 may be used to display the screens described above. The display panel 141 may be created using liquid crystal display elements, self-emissive display elements or the like. The display panel 141 may display images or items corresponding to a touch region mapping of the touch panel 143.

The touch panel 143 is configured to sense an electrical change caused by a touch gesture and transmit the sensing result to the control unit 160. The touch panel 143 is configured to cover at least a portion of the display panel 141. In particular, where one or more thumbnails are displayed on the display panel 141, the touch panel 143 may generate an input event for selecting an item associated with a specific thumbnail or for scrolling based on detection of user control. Operations that a user may perform on the display unit 140, including the display panel 141 and the touch panel 143, are described in more detail later with reference to the drawings.

The storage unit 150 may store various programs and data needed for operation of the mobile terminal 100. For example, the storage unit 150 may store an operating system for the mobile terminal 100 and other programs supporting the display of the user interface on the display panel 141. In particular, the storage unit 150 may store a dynamic image manipulation program 151 and thumbnail groups 153 to support the dynamic image manipulation approach described herein.

In one aspect of the invention, dynamic image manipulation program 151 provides dynamic image manipulation-related functionality. When an input event is generated when a listing screen containing representative thumbnails of the thumbnail groups 153 is displayed on the display unit 140, the dynamic image manipulation program 151 may dynamically change the representative thumbnails based on the input event. To this end, the dynamic image manipulation program 151 may include algorithmic routine for retrieving the thumbnail groups 153 associated with a display function on the display unit 140, an algorithmic routine for receiving an input event, and an algorithmic routine for changing thumbnails displayed on the display unit 140 based on a received input event.

The dynamic image manipulation program 151 may further include an algorithmic routine for creating a new thumbnail group 153. For example, when one thumbnail is associated with an entry of a specific list, the dynamic image manipulation program 151 may include an algorithmic routine for adjusting the thumbnail to generate multiple thumbnails, and an algorithmic routine for creating a thumbnail group 153 containing the initial thumbnail and generated thumbnails.

The thumbnail group 153 may contain a representative thumbnail associated with an entry of a specific list and multiple thumbnails related the representative thumbnail. For the dynamic image manipulation in the present invention, the representative thumbnail currently displayed on the display unit 140 is replaced with a different thumbnail contained in the thumbnail group 153 in response to a reception of an input event. Hence, one thumbnail group 153 may contain a representative thumbnail and also thumbnails similar to the representative thumbnail.

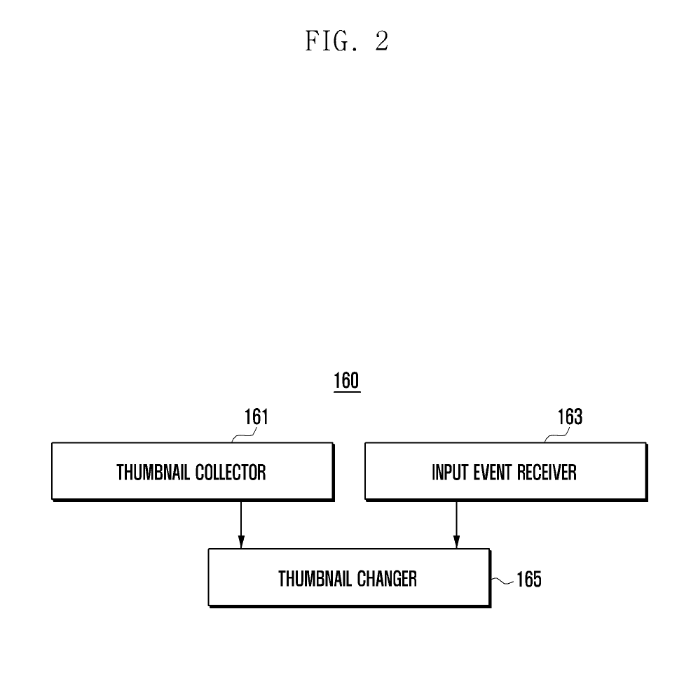

The control unit 160 may include components necessary for supporting the dynamic image manipulation approach of the present invention. The control unit 160 may perform signal processing, data processing, and control operations based on the components to support the dynamic image manipulation approach described herein. To this end, the control unit 160 may have a configuration shown in FIG. 2.

FIG. 2 illustrates a functional representation of a configuration of the control unit 160 in the mobile terminal 100 configured in accordance with the present invention.

Referring to FIG. 2, the control unit 160 may include a thumbnail collector 161, an input event receiver 163, and a thumbnail changer 165.

The thumbnail collector 161 may determine, when a function is invoked, whether the function requires a display of one or more thumbnails. When the function requires the display of one or more thumbnails, the thumbnail collector 161 retrieves any of the thumbnails from the thumbnail groups 153 related to the function from the storage unit 150. The thumbnail collector 161 may transmit the retrieved thumbnails from the thumbnail groups 153 to the thumbnail changer 165.

The input event receiver 163 receives various input events generated by the mobile terminal 100. For example, the input event receiver 163 may receive a scroll event generated by user interaction with the touch panel 143 or a selection event for selecting a particular entry on a listing screen. The input event receiver 163 may also receive, as an input event, an event indicating reception of a message, an event indicating composition or reception of an instant message, an event indicating reception or composition of an email message, or an event indicating call placement to an external mobile terminal associated with a list entry. The input event receiver 163 may send a received event to the thumbnail changer 165. When no input occurs after a preset time, the input event receiver 163 may send an end-of-input event to the thumbnail changer 165.

The thumbnail changer 165 may change thumbnails contained in a thumbnail group 153 sent by the thumbnail collector 161 based on an input event received from the input event receiver 163. For example, the thumbnail changer 165 may output a representative thumbnail of one of the thumbnail groups 153 on the display unit 140 by default. In response to a scroll event, the thumbnail changer 165 may replace the representative thumbnail with another thumbnail chosen from multiple thumbnails of the thumbnail groups 153 based on a scroll direction. In response to a selection event, the thumbnail changer 165 may change the representative thumbnail into thumbnails configured based on a selection event. For example, the thumbnail changer 165 may create a thumbnail group. That is, the thumbnail changer 165 may extract feature elements [Steve, what are feature elements?] from the displayed thumbnail, create multiple thumbnails by modifying some of the feature elements, and form a thumbnail group composed of the initially displayed thumbnail and the created thumbnails. Various aspects of the dynamic image manipulation approach implemented by the thumbnail changer 165 are described in more detail herein with reference to the drawings.

As described above, the mobile terminal 100 may replace thumbnails displayed on various screens with different thumbnails based on received input events. Hence, the user may use the mobile terminal 100 in an emotionally appealing [Comments:, what do they mean by “emotionally appealing”? Do they mean “pleasing”?] way and receive feedback an input event.

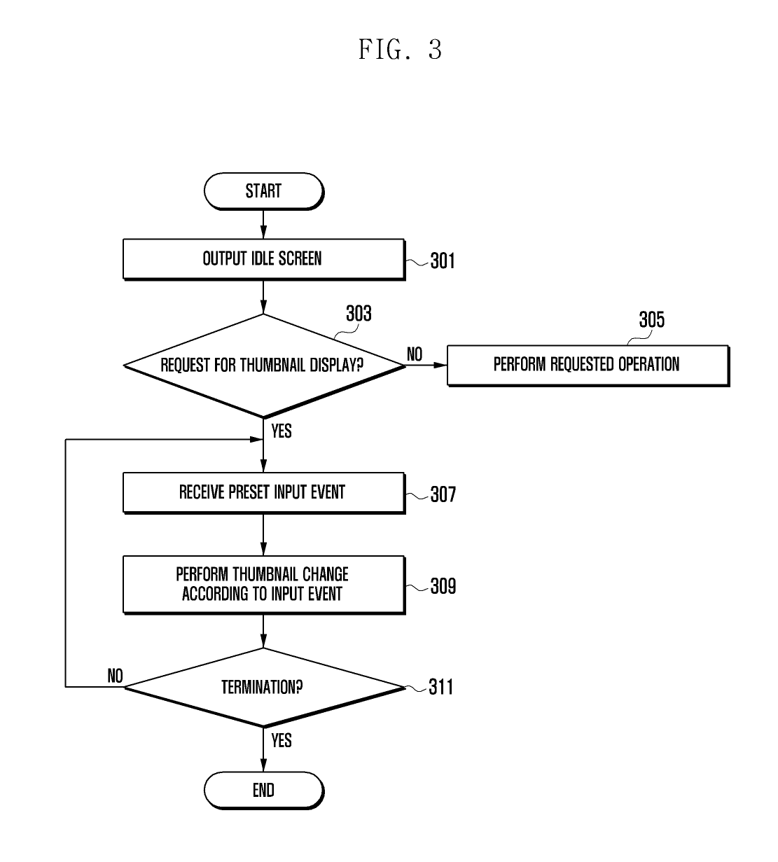

FIG. 3 is a flowchart of one aspect of the dynamic image manipulation approach configured in accordance with another embodiment of the present invention.

Referring to FIG. 3, the control unit 160 of the mobile terminal 100 may control the display unit 140 so as to configure and output of an idle screen according to preset scheduling information (301). At this stage, the control unit 160 may perform other operations. For example, the control unit 160 may activate a specific function according to preset scheduling information and output a corresponding functional screen on the display unit 140. The control unit 160 may also block the supply of power to the display unit 140 and cause the mobile terminal 100 to enter a sleep state.

When an input signal is generated by the input unit 120 or display unit 140 acting as an input means, the control unit 160 determines whether the input signal is related to a thumbnail display (303). When the input signal is not related to the thumbnail display, the control unit 160 performs an operation requested by the input signal (305). For example, the control unit 160 may control an operation to access a website, receive broadcasts, or conduct a search based on the input signal.

When the input signal directed to thumbnail display, the control unit 160 may display a screen containing thumbnails selected by the input signal and receives a preset input event (307). Examples of a screen containing thumbnails may include a phonebook list screen containing thumbnails, a message log screen containing thumbnails, a call log screen containing thumbnails, an email log screen containing thumbnails, an instant messaging screen containing thumbnails, or a playlist screen containing thumbnails. Examples of an input event may include an event for selecting a list entry associated with a thumbnail, an event indicating reception of a message associated with a list entry from the outside, a scroll event on a listing screen, or an event indicating call placement.

The control unit 160 may manipulate the thumbnails according to the received input event (309). For example, using one or more thumbnails from the thumbnail groups 153, the control unit 160 may replace the currently displayed thumbnail with a different thumbnail contained in the thumbnail groups 153. That is, displayed thumbnails may be exchanged based on an input event.

For a change to a thumbnail, versus a thumbnail replacement, the control unit 160 may change one or more visual elements constituting a displayed thumbnail based on an input event. For example, in the case of an image of a human figure serving as a thumbnail, the control unit 160 may change a color of at least one of a background element and an image element, or may change a color or shape of the head, arm, finger, clothes, or other portion of the human figure in the thumbnail.

For example, the control unit 160 may further include an image renderer (not shown) to alter the visual elements of a thumbnail. When the control unit 160 includes an image renderer, which may change a thumbnail by rendering a specific element of the thumbnail, the thumbnail collector 161 may not have to be used. Thumbnail manipulation may be temporary or semi-permanent. For example, changes to a background element or other visual elements of a thumbnail may have a semi-permanent effect (i.e., the thumbnail is changed semi-permanently). Thumbnail changes caused by a scroll event may also be temporary. That is, the control unit 160 may alter the appearance of the thumbnails being displayed while a scroll event is effective, and may stop the visual alterations to restore the initially displayed thumbnails when the scroll event ends.

The control unit 160 may determine whether an input signal for termination is generated (311). If it is determined that an input signal for termination is not generated, the control unit 160 may return to 307 and continue the process from there.

As described above, the dynamic image manipulation approach of the present invention may alter thumbnails based on input events for a screen containing thumbnails so as to provide an emotionally appealing display to the user.

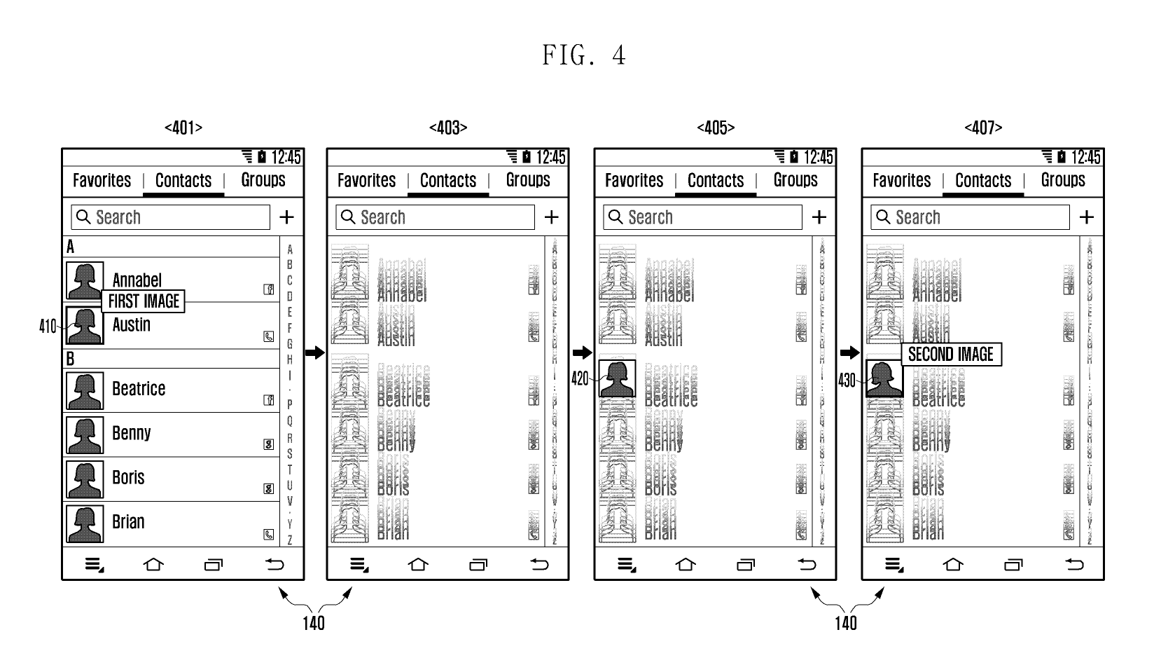

FIG. 4 illustrates thumbnail alteration and display approach based on a receipt of a scroll event in accordance with the dynamic image manipulation process described herein. Some of the drawings illustrate screen changes based on a scroll event; and, for ease of description, some thumbnails are depicted as being stopped during scrolling.

Referring to FIG. 4, the mobile terminal 100 may output a listing screen including multiple items associated with thumbnails on the display unit 140 based on a user request or preset scheduling information, as indicated by reference numeral 401. For example, the mobile terminal 100 may display a listing screen containing a phonebook list, a received message list, a received email list, or an instant message list according to an input signal. Each entry of the listing screen may have a thumbnail serving as a photo ID located on a left portion of the entry as exemplified by a thumbnail for “Austin” referenced using reference numeral 410. Here, the displayed thumbnail 410 may be a representative thumbnail of the corresponding thumbnail group 153.

Upon display of the listing screen on the display unit 140, the mobile terminal 100 may activate the touch panel 143. Thereafter, when the user inputs a scroll event through the touch panel 143 of the display unit 140, the scroll event is delivered to the control unit 160. The control unit 160 may scroll the screen based on receipt of the scroll event in various manners, such as that shown in the screens referenced by numerals 403, 405 and 407. In particular, screen 407 indicates that the thumbnails 410 are replaced by thumbnails 430 based on the receipt of a scroll event. For example, whereas the thumbnail 420 in the screen 405 has an upright symmetric head, sometime later, the thumbnail 430 as shown in the screen 407 has a tilted head.

As described above, the present invention may support dynamic thumbnail alteration and display by replacing displayed thumbnails, which may be output as static images, with different thumbnails based on an input event. In the example from the above description, screen changes are caused by exchanging all thumbnails displayed on the screen in response to an occurrence of a scroll event.

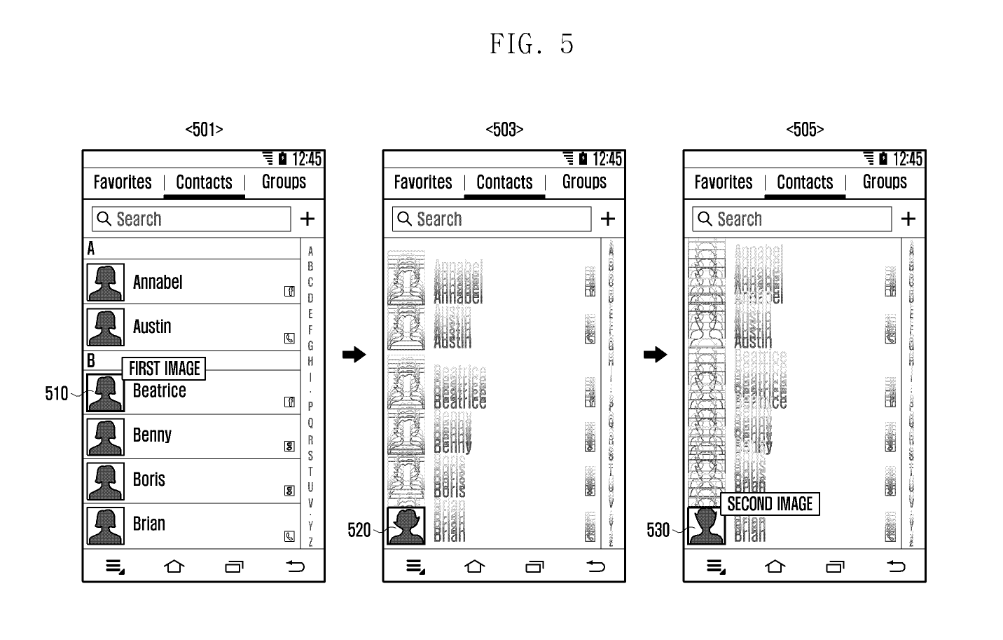

FIG. 5 illustrates another thumbnail alteration and display process based on a receipt of a scroll event configured in accordance with one aspect of the dynamic image manipulation approach described herein.

Referring to FIG. 5, which includes screens similar to FIG. 4, the mobile terminal 100 may output a listing screen, including multiple items associated with thumbnails 510 on the display unit 140 based on a user request or preset scheduling information, as indicated by a reference numeral 501. For example, the mobile terminal 100 may display a listing screen containing a phonebook list, a received message list, a received email list, or an instant message list based on an input signal.

The mobile terminal 100 may receive a scroll event based on a user action. When a scroll down event is received, the control unit 160 may move the list entries downward as illustrated by the screen 503. In this process, the control unit 160 may change elements of displayed thumbnails 520 so as to represent speed of screen changes in an emotionally appealing way. Elements of the thumbnails 520 may be changed differently according to a detected speed of scroll events. For example, as shown in the screen 503, a hairstyle of the thumbnail 520 is changed to represent effects of gravity and wind corresponding to downward movement.

When the last list entry is displayed on the display unit 140 because of the scrolling of the list, as shown by the screen 505, the control unit 160 may again change the thumbnail 530 of the last entry to vividly represent screen changes. For example, the hairstyle of the thumbnail 530 of the last entry is changed differently from those of thumbnails of the other entries so as to clearly indicate the end of the list in an emotionally appealing way. In addition, the thumbnail 530 of the last entry in the list may be changed back to the original thumbnail after a preset time. That is, to vividly represent screen changes, the thumbnail 530 of the last entry in the list may be replaced by different thumbnails in sequence with passage of time. For example, as shown in the screen 505, the hair of the thumbnail 530 may be raised up to a given height and then gradually lowered to the original height with passage of time, thereby presenting an effect that the hair of the thumbnail 530 may be are raised owing to movement and then lowered owing to gravity.

To support features described in connection with FIGS. 4 and 5, the mobile terminal 100 may display representative thumbnails of selected thumbnail groups from the thumbnail groups 153 on the listing screen and replace the displayed thumbnails with different thumbnails from the thumbnail groups 153 based on an input event. In particular, to represent a sense of speed as depicted in FIG. 5, the mobile terminal 100 may determine a speed of movement of a scroll event and alter the way in which the thumbnails are displayed accordingly. To this end, for one representative thumbnail, the mobile terminal 100 may store a thumbnail group composed of different thumbnails corresponding to various speed levels of a scroll event. Hence, to display multiple representative thumbnails on a listing screen, the mobile terminal 100 may store multiple thumbnail groups, each of which is composed of different thumbnails.

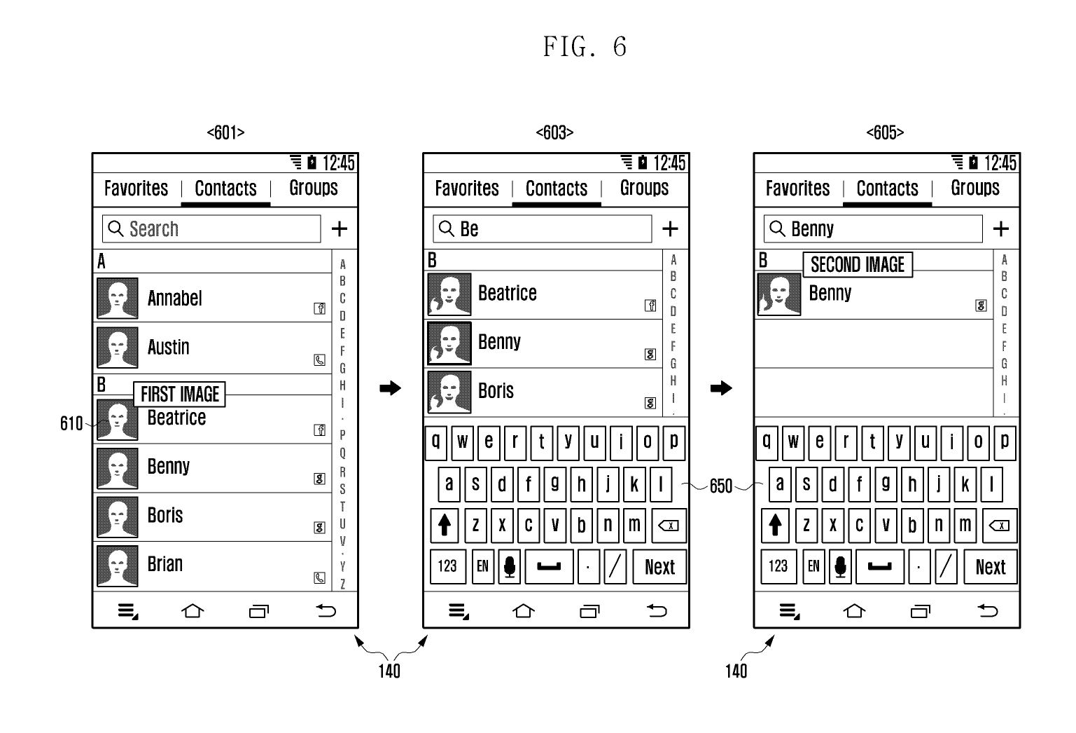

FIG. 6 illustrates a thumbnail alteration and also play process based on use of a search term configured in accordance with one aspect of the dynamic image manipulation approach disclosed herein.

Referring to FIG. 6, the mobile terminal 100 may output a listing screen including multiple items associated with thumbnails 610 on the display unit 140 according to a user request or preset scheduling information as indicated by reference numeral 601.

When the user issues a search request, the mobile terminal 100 may output an onscreen keyboard 650 for entering a search term on the display unit 140 as shown by a screen 603. Along with display of the onscreen keyboard 650, the number of list items displayed on the screen may be adjusted. To locate desired list items, the user may enter a search term using the onscreen keyboard 650. As the user enters the search term, the mobile terminal 100 may perform a predictive search using the information being entered, and output the search result on the display unit 140 as shown by the screen 603 and a screen 605. For example, when the user enters ‘B’ using the onscreen keyboard 650, the control unit 160 finds list items whose names contain ‘B’ among all list items and outputs the search result on a region of the screen. When the user enters “Be” using the onscreen keyboard 650, the control unit 160 finds list items whose names contain “Be” and outputs the search result on the display unit 140 as shown by the screen 603. Continuing to refer to FIG. 5, a screen 605 shows that the user has entered “Benny” as a complete search term and the corresponding search result (one item) is output on the display unit 140.

In a search process, the control unit 160 may successively change thumbnails of items found using parts of a search term being entered. For example, the control unit 160 displays representative thumbnails from the thumbnail groups 153 for list items as shown by the screen 601. When a part of the search term is entered, the control unit 160 replaces displayed thumbnails of list items corresponding to the partial search term with different thumbnails from the thumbnail groups 153 as shown by the screen 603. When the complete search term is entered, the control unit 160 replaces the displayed thumbnail of a list item matching the search term with a different thumbnail from the corresponding thumbnail group 153 as shown by the screen 605.

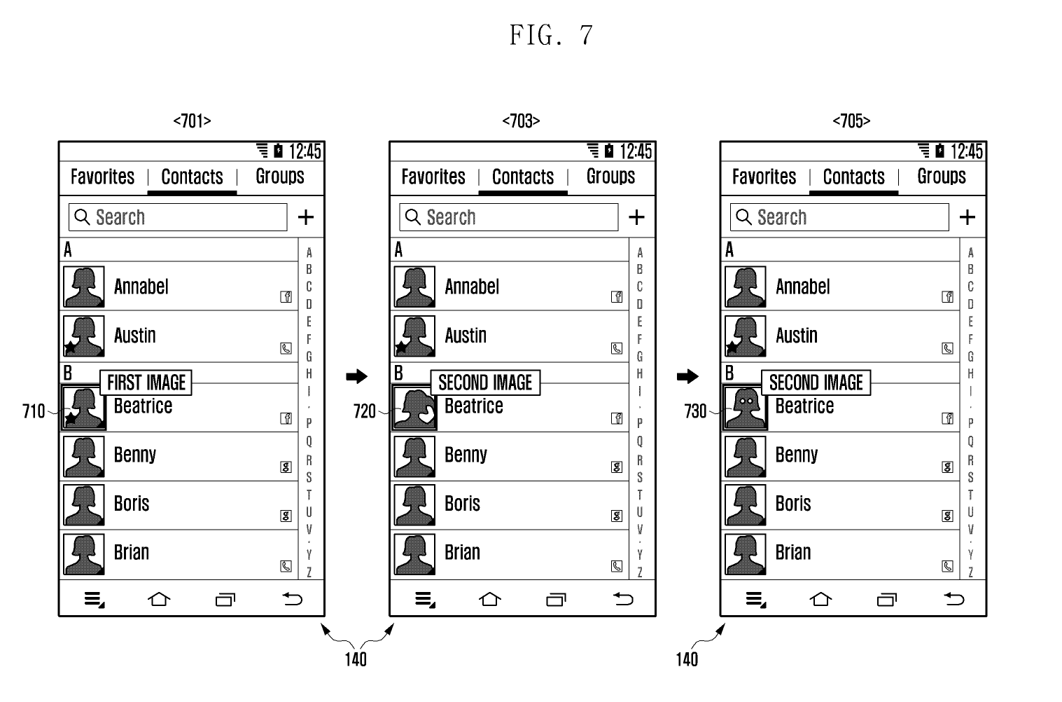

FIG. 7 illustrates a thumbnail modification and display process with passage of time configured in accordance with dynamic image manipulation approach described herein.

Referring to FIG. 7, the mobile terminal 100 may output a listing screen including multiple items associated with thumbnails on the display unit 140 as shown by a screen 701. Thereafter, when a preset time expires without receipt of an input event, the mobile terminal 100 may change a displayed thumbnail 710 of a list item into a different thumbnail 720 or 730. Here, the control unit 160 may select at least one item among list items displayed on the display unit 140 randomly or according to a given condition, and change the thumbnail 710 of the selected list item into a different thumbnail 720 or 730 as shown by screens 703 or 705. In particular, the control unit 160 may control a display of differences between the previous thumbnail 710 and the next thumbnail 720 or 730 so as to reflect elapsed time.

To select a list item whose thumbnail is to be changed, the control unit 160 may refer to usage histories or configuration options as to list items displayed on the display unit 140. For example, the control unit 160 may select a list item among list items output on the display unit 140 according to predetermined preferences. The control unit 160 may select a frequently used list item or a most recently used list item among list items output on the display unit 140.

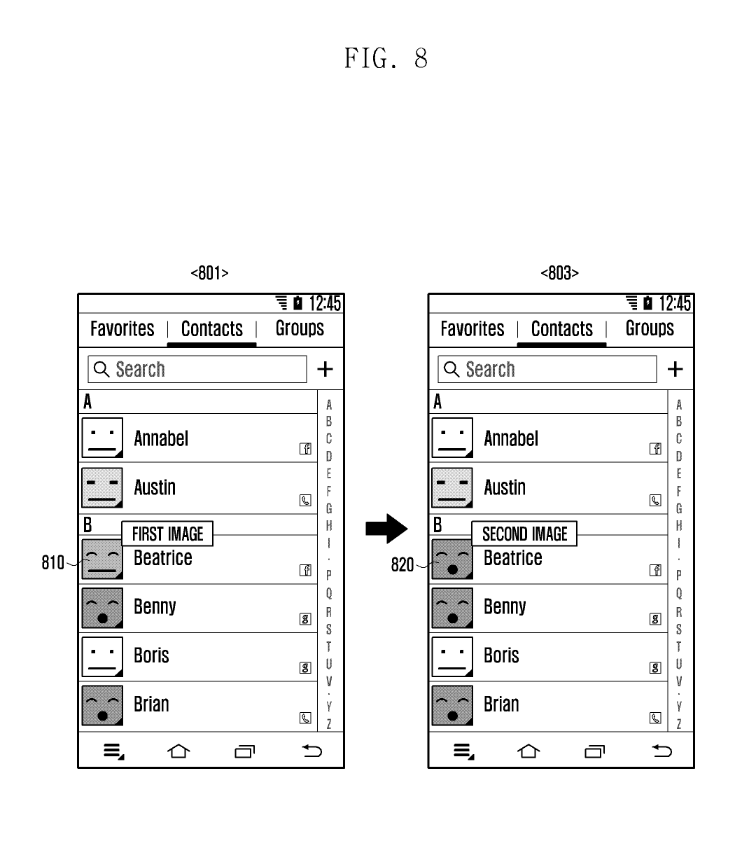

FIGS. 8 to 10 illustrate a thumbnail modification and display process based on usage histories configured with one aspect of the dynamic image manipulation approach described herein.

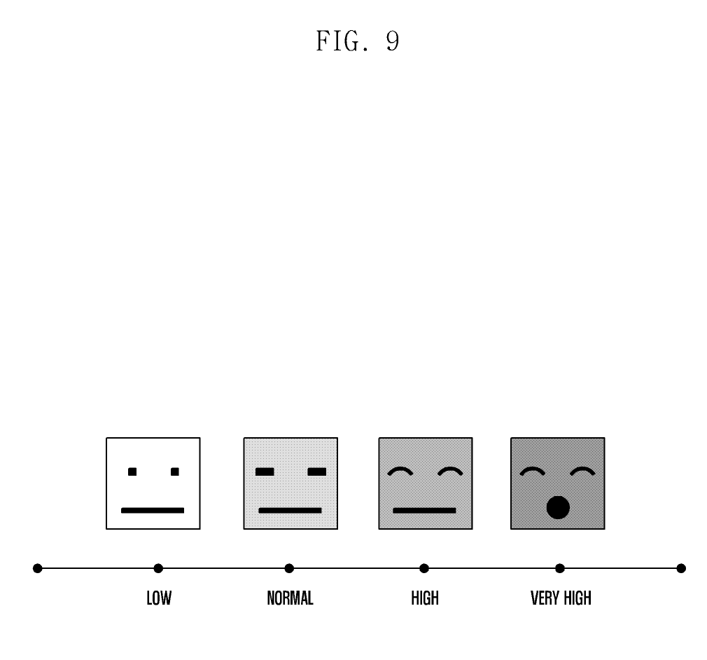

Referring to FIGS. 8 to 10, the mobile terminal 100 may output a listing screen including multiple items associated with different thumbnails on the display unit 140 as indicated by reference numeral 801. Here, thumbnails of list items may be determined according to usage histories of the list items. For example, as shown in FIG. 9, different thumbnails may be assigned to list items according to the usage frequency (low, normal, high, and very high).

When the list item having a first thumbnail 810 corresponding to a usage frequency “high” is repeatedly selected for use as shown by a screen 801, the control unit 160 may replace the first thumbnail 810 with a second thumbnail 820 corresponding to a usage frequency of “very high” as shown by numeral screen 803.

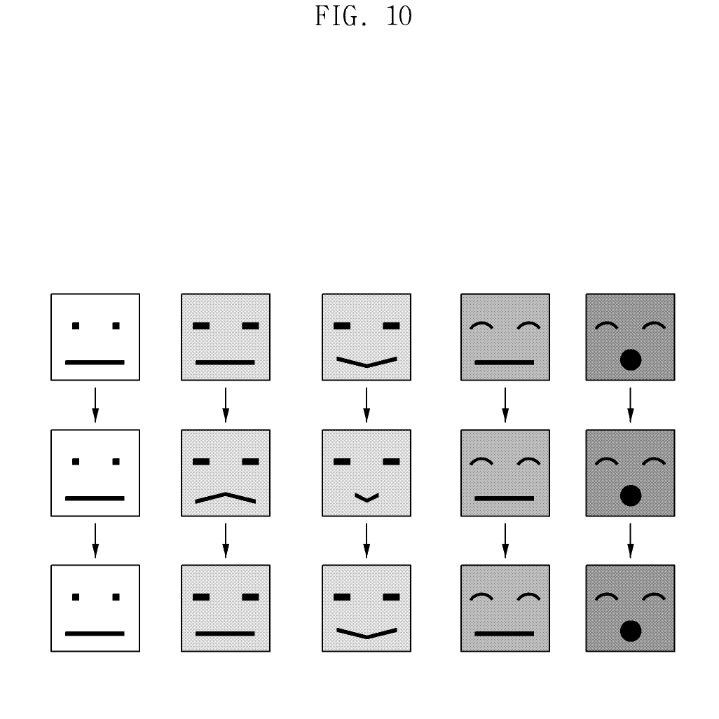

Referring to FIG. 10, thumbnails may be modified, with an animation effect. For example, when thumbnails of list items are displayed as indicated by the screen 801, the individual thumbnails may be changed in sequence as shown in FIG. 10, with passage of time. In FIG. 10, thumbnails are depicted as being changed in two stages. However, the present invention is not limited thereto. That is, thumbnails may be changed in more than two stages according to the number of thumbnails contained in corresponding thumbnail groups.

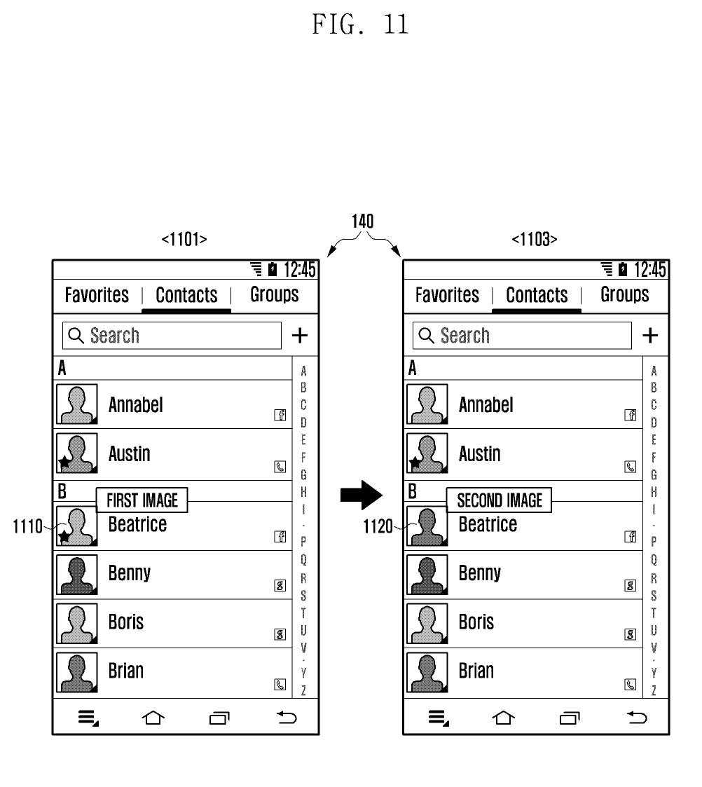

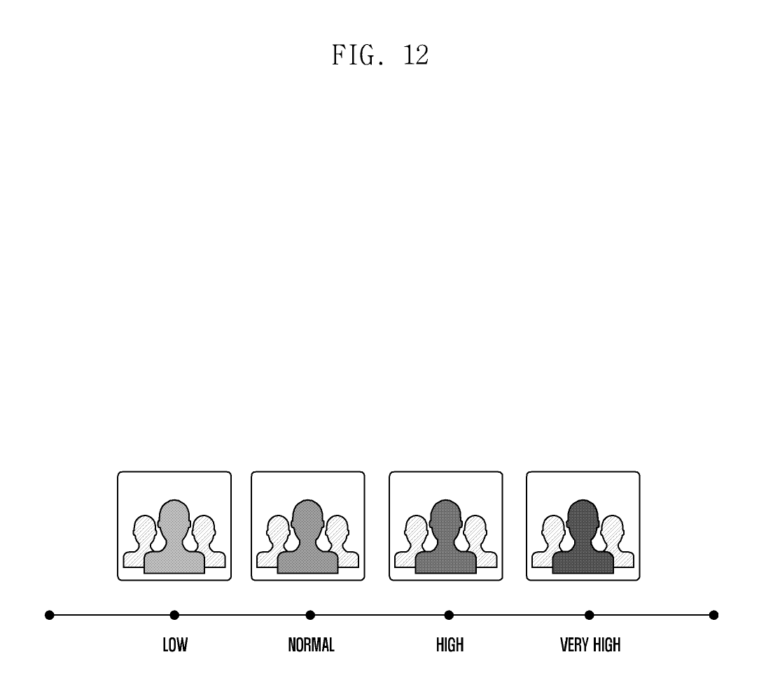

FIG. 11 illustrates modification of thumbnail colors based on usage histories configured in accordance with one aspect of the dynamic image manipulation approach described herein, and FIG. 12 illustrates modification of thumbnail colors and transparencies based on usage histories.

Referring to FIG. 11, the mobile terminal 100 may output a listing screen including multiple items associated with thumbnails on the display unit 140 according to a user request or preset scheduling information as indicated by numeral screen 1101. Here, thumbnails displayed on the listing screen may differ in at least one of color and transparency based on usage histories of corresponding list items. When the usage history of a displayed list item is changed, the control unit 160 may change at least one of the color and transparency of the thumbnail associated with the list item, as shown by a screen 1103. For example, when the usage history of a list item associated with a thumbnail 1110 is changed due to user selection or message reception as shown by the screen 1101, the control unit 160 may replace the thumbnail 1110 with a different thumbnail 1120 as shown by a screen 1103. As shown in FIG. 12, thumbnail modification based on color and transparency may be performed with reference to usage frequency levels (low, normal, high, and very high). That is, for a list item, the thumbnail at a time when the list item is rarely used may differ in color and transparency from that at a time when the list item becomes frequently used.

Usage histories described in connection with FIGS. 8 to 12 may be related to call connection, selection, playback, message reception or the like during operation of the mobile terminal 100. Usage of phonebook items may be related to message reception, call connection and selection in combination. Hence, the mobile terminal 100 may perform thumbnail modification according to single usage history or composite usage histories for specific list items.

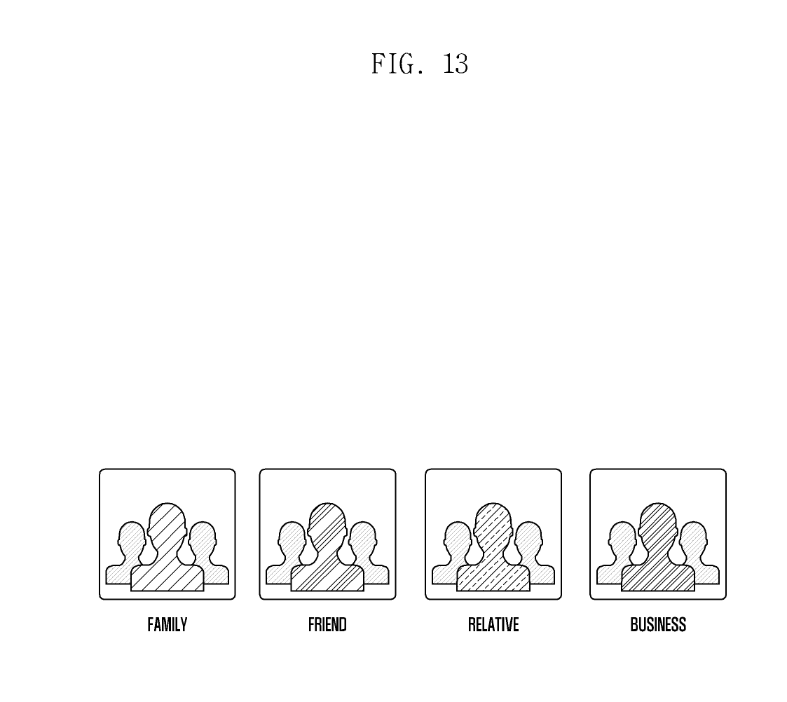

FIG. 13 illustrates image changes according to user settings during dynamic manipulation.

Referring to FIG. 13, phonebook items may be classified into user specified categories and thumbnails associated with phonebook items assigned to different categories may differ in at least one of color and transparency. For example, phonebook items may be classified into categories such as family, friend, relative, and business. Phonebook items assigned to the “family” category may be associated with a thumbnail having a specific color and transparency. Likewise, phonebook items assigned to the “friend”, “relative”, or “business” category may be associated with a thumbnail having a specific color and transparency. Colors and transparencies of thumbnails associated with list items assigned to a specific category may be adjusted according to user control.

In this case, thumbnails of phonebook items belonging to the same category may have different shapes but may be set to have the same color. Hence, the mobile terminal 100 enables the user to readily recognize the category to which a specific phonebook item is assigned in a list of phonebook items that are not sorted by category (for example, an alphabetically ordered list).

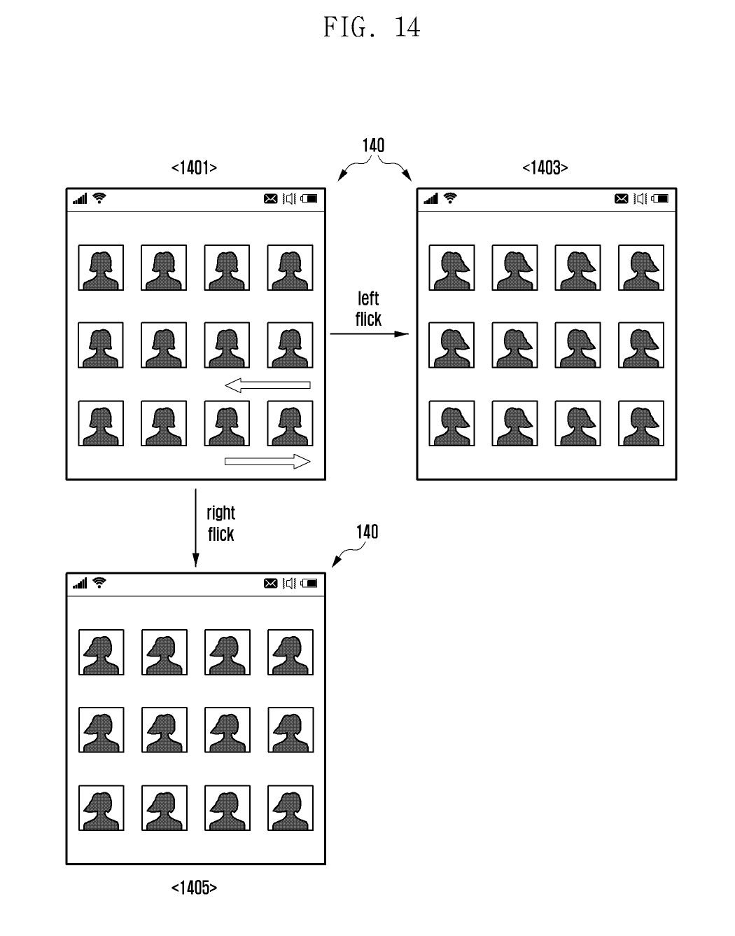

FIG. 14 illustrates modification of multiple thumbnails during dynamic image manipulation.

Referring to FIG. 14, the mobile terminal 100 may output a multi-thumbnail view screen including multiple items associated with thumbnails on the display unit 140 according to a user request or preset scheduling information as shown by a screen 1401. A multi-thumbnail view screen may be used in a manner similar to the previously described listing screen. For example, the mobile terminal 100 may output a multi-thumbnail view screen for searching music files, browsing phonebooks, browsing received messages, and viewing galleries. That is, items or entries used in a specific function or feature may be output on a listing screen as described before or be output on a multi-thumbnail view screen as shown in FIG. 14.

When a left-flick event occurs in the screen 1401, the control unit 160 may move the multi-thumbnail view screen in the left direction on the display unit 140. Here, thumbnails on the multi-thumbnail view screen may be replaced with different thumbnails indicating movement to the left as shown by a screen 1403. Upon release of the left-flick event, the control unit 160 may output representative thumbnails corresponding to a static screen state where the left-flick event has been applied on the display unit 140.

When a right-flick event occurs in a screen 1401, the control unit 160 may move the multi-thumbnail view screen in the right direction on the display unit 140. Here, thumbnails on the multi-thumbnail view screen may be replaced with different thumbnails indicating movement to the right as shown by a screen 1405. Upon release of the right-flick event, the control unit 160 may output representative thumbnails corresponding to a static screen state where the right-flick event has been applied on the display unit 140.

A flick event is a form of scroll event and may be generated by a touch gesture involving touch-down and movement in a direction by a specific distance with a speed on the touch panel 143. A flick event may be generated by a sweep action. In addition to a flick event, a drag event may be applied to the dynamic thumbnail modification approach of the present invention. Here, a drag event may be generated by a touch gesture involving touch-down and movement without touch-release on the touch panel 143.

As described above, various aspects of the dynamic image manipulation approach of the present invention enables the mobile terminal 100 to modify thumbnails based on input events. Hence, the mobile terminal 100 may represent a variety of information in an emotionally appealing way, and the user may readily recognize screen information provided by the mobile terminal 100.

In the above description, thumbnails are depicted as having a human shape or human-face shape. However, the present invention is not limited thereto. That is, thumbnails may include a variety of different shapes, including icons or images, or abstract representatives of animal, people, devices, and trees or any other desired representation.

The mobile terminal 100 may further include various components depending on a desired implementation. That is, when the mobile terminal 100 is a communication terminal, it may further include a local-area network (LAN) communication module for communication on a LAN, a data communication interface based on wired and wireless communication, an Internet communication module for Internet access, or a digital broadcast reception module for playing back digital broadcasts. With the trend towards digital convergence, it should be apparent to those skilled in the art that the mobile terminal 100 may further include multiple units comparable to one or more of the above-described units, and one or more units of the mobile terminal 100 may be removed or replaced with another unit.

The mobile terminal 100 of the present invention may be any information and communication appliance, or multimedia appliance, such as a mobile communication terminal based on communication protocols supporting various communication systems, a portable multimedia player (PMP), a digital broadcast receiver, a personal digital assistant (PDA), a music player like an MP3 player, a portable game console, a smartphone, a laptop computer, or a handheld computer.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Hereinabove, exemplary embodiments of the present invention have been described with reference to the accompanying drawings. Specific terms or words used in the description should be construed in accordance with the spirit of the present invention without limiting the subject matter thereof. It should be understood that many variations and modifications of the basic inventive concept described herein will still fall within the spirit and scope of the present invention as defined in the appended claims.

What is claimed is:

1. A method for dynamic image manipulation, comprising:
outputting at least one thumbnail on a display;
receiving an input event based on the display, the input event comprising of at least one property; and
performing image modification by changing at least one of the shape, color, or transparency of the at least one thumbnail based on the at least one property of the input event.

2. The method of claim 1, wherein the outputting of the at least one thumbnail comprises:
examining a usage history of an item with which a first thumbnail is associated; and
outputting a second thumbnail having at least one of the modified color and transparency corresponding to the usage history to replace the first thumbnail.

3. The method of claim 1, wherein the performing of image modification comprises:
collecting a thumbnail group comprising multiple thumbnails related to the at least one thumbnail; and
replacing, upon the reception of the input event, the at least one thumbnail with at least one different thumbnail, from the thumbnail group.

4. The method of claim 3, further comprising:
collecting image elements of the at least one thumbnail;
generating a plurality of thumbnails by modifying some of the image elements; and
creating the thumbnail group containing the plurality of thumbnails and the at least one thumbnail.

5. The method of claim 1, wherein the performing of the image modification comprises:
collecting image elements of a displayed thumbnail; and
replacing, upon reception of an input event, the displayed thumbnail with a new thumbnail created through rendering at least one of the image elements.

6. The method of claim 1, wherein the receiving of the input event comprises at least one of:
receiving a scroll event to the screen in a given direction and display new thumbnails associated with different items based on the movement;
receiving a selection event to select one of a set of thumbnails associated with a variety of items;
receiving a notification event to indicate reception of an email, text, or instant message from in connection with an item associated with a thumbnail; and
receiving a call connection event to place or receive a call in connection with an item associated with a thumbnail.

7. The method of claim 6, wherein the performing of the image modification comprises:
identifying, upon reception of the scroll event, a screen change direction; and
displaying thumbnails modified to represent the screen change direction.

8. The method of claim 6, wherein the performing of the image modification comprises:
identifying, upon reception of the scroll event, a speed of the scroll event; and
displaying thumbnails modified to represent the speed of the scroll event.

9. The method of claim 8, wherein the performing of the image modification comprises:
identifying a last item of a list in accordance with an operation of the scroll event;
replacing a previously displayed thumbnail with a thumbnail associated with the identified last item; and
re-displaying of the previously displayed thumbnail upon expiration of a preset time.

10. The method of claim 6, wherein the performing of the image change comprises:
applying at least one of a selection event, a notification event, or a call connection event to a corresponding item and updating a usage history of the corresponding item; and
replacing a currently displayed thumbnail associated with the corresponding item with a different thumbnail according to the updated usage history.

11. A mobile terminal comprising:
a display unit configured to output at least one thumbnail;
at least one of a communication unit, an input unit, or a touch panel configured to receive an input event; the input event comprising at least one property; and
a control unit configured to change at least one of the shape, color, or transparency of the at least one thumbnail according to the at least one property of the input event.

12. The mobile terminal of claim 11, wherein the control unit is further configured examine a usage history of an item to which a thumbnail is assigned and outputting a version of the thumbnail comprising a color and transparency corresponding to the usage history.

13. The mobile terminal of claim 11, wherein the control unit is further configured to collect a thumbnail group comprising multiple thumbnails related to the at least one thumbnail, and replace, upon reception of an input event, a currently displayed thumbnail with a different thumbnail, wherein the currently displayed thumbnail and the different thumbnail are associated with the collected thumbnail group.

14. The mobile terminal of claim 11, wherein the at least one thumbnail comprises a plurality of image elements and control unit is configured to generate at least one other thumbnail by modifying at least one of the image elements to create a thumbnail group.

15. The mobile terminal of claim 14, wherein the control unit is further configured to replace, upon receiving an input event, a displayed thumbnail with another thumbnail from the thumbnail group.

16. The mobile terminal of claim 11, wherein the touch panel is configured to receive a scroll event as the input event to display new thumbnails associated with different items by moving a screen presented by the display unit in an associated direction.

17. The mobile terminal of claim 16, wherein the control unit is farther configured to identify the associated direction indicated by the received scroll event and displaying modified thumbnails to reflect movement in the associated direction.

18. The mobile terminal of claim 16, wherein the control unit is further configured to identify a speed of the received scroll event and display modified thumbnails configured to represent the speed of the scroll event.

19. The mobile terminal of claim 16, wherein the control unit is further configured to identify the last item of a list in accordance with operation of the scroll event; replace a previously displayed thumbnail with another thumbnail associated with the identified last item; and recover the previously displayed thumbnail upon expiration of a preset time.

20. The mobile terminal of claim 11, wherein at least one of the input unit and the communication unit is further configured to receive at least one of:
a selection event to select one of displayed items associated with thumbnails; a notification event to indicate reception of an email, text, or instant message in connection with an item associated with a thumbnail; and a call connection event to place or receive a call in connection with an item associated with a thumbnail; and
wherein the control unit is further configured to apply at least one of a selection event, notification event, or a call connection event to a corresponding item; update a usage history of the item; and replace a currently displayed thumbnail associated with the item with a different thumbnail based on the updated usage history.
